(19) United States
(12) Patent Application Publication
(10) Pub. No.: US 2012/0040053 A1
(43) Pub. Date: Feb. 16, 2012

(54) METHOD FOR PRODUCING AN ACIDIFIED MILK PRODUCT

(75) Inventors: Ebbe Lund Rasholt, Soeborg (DK); Christian Gilleladen, Copenhagen V (DK); Hans Christian Bejder, Hoersholm (DK); Merete Faergemand, Alleroed (DK)

(73) Assignees: NOVOZYMES A/S; CHR-HANSEN A/S

(21) Appl. No.: 13/147,731

(22) PCT Filed: Feb. 5, 2010
(86) PCT No.: PCT/EP2010/051444

§ 371 Date: Oct. 6, 2011

(30) Foreign Application Priority Data
Feb. 5, 2009 (DK) PA 2009 00181
Feb. 5, 2009 (DK) PA 2009 00182

(51) Int. Cl. A23C 9/127; A23C 9/12

(52) U.S. Cl. 426/43; 426/42; 426/580

(57) ABSTRACT

The present invention relates to a method for producing an acidified product using an enzyme having transglutaminase activity.

### TECHNICAL FIELD

The present invention relates to a method for producing an acidified milk product with improved shelf life, reduced post-acidification, improved flavour stability, improved sedimentation stability, and/or improved mouth feel.

### BACKGROUND OF THE INVENTION

The market for acidified milk products, which includes fermented milk drinks and liquid yoghurt, is increasing worldwide and there is an interest in improving the quality and economics of this product.

Acidified milk drinks are generally produced by mixing acidified milk with a sugar syrup solution, and subjecting the mixture to a homogenization treatment. Acidification may take place through addition of a chemical, such as glucono delta-lactone (GDL), or lactobionic acid (LBA), or it may be caused by fermentation of the milk with lactic acid bacteria. When such fermented products are stored, however, the lactic acid bacterial cultures used for the acidification of fermented milks usually continue to produce lactic acid during the shelf life of the fermented milk product. This phenomenon is often referred to as “post-acidification”.

Drinkable yoghurt differs from stirred yoghurt regarding milk base (dry matter concentration) as well as production process and sensory requirements. There are significant differences between the texture challenges for these two yoghurt segments. For drinkable yoghurt, a high shear treatment (e.g. homogenization) after fermentation is needed to break down the protein network in order to obtain smooth, homogeneous and drinkable products. The breakdown of the network implies that drinking yoghurts have a reduced sedimentation stability, resulting in sedimentation of protein to the bottom during shelf life. High fat revels and high protein content increase sedimentation stability, while low fat products (0-0.5% fat) with reduced protein levels (1-3%) needs addition of a stabilizer to avoid protein sedimentation. The most effective stabilizer normally used in drinking yoghurt is pectin. Post treatment homogenisation of at least 100 bar of the mix of yoghurt/pectin is needed to stabilize drinking products to obtain sedimentation stability. This implies a reduction in viscosity (or mouth feel) which partly can be overcome by increasing the level of pectin addition, though a costly solution for the dairies.

A trend in the market for fermented milks is products with a moderate to a non-existent development of acidity during shelf life (low post-acidification). In the prior art, post-acidification is addressed by introduction of novel lactic acid bacterial strains, see e.g. WO2007147890A1.

It is an objective of the present invention to provide a method for manufacturing of a pectin-free stable acidified milk drink with long shelf life, e.g. where sedimentation upon storage is reduced compared to a standard pectin-free acidified milk drink. Also, it is an objective of the present invention to provide a method for manufacturing of a fermented milk drink with improved mouth feel compared to a standard pectin-free acidified milk drink. Mouth feel is a product's physical and chemical interaction in the mouth, an aspect of food rheology. It is evaluated from initial perception on the palate, through swallowing to aftertaste. An other objective is to provide a method for manufacturing a acidified milk drink wherein some of the pectin is replaced by other thickeners or by enzymatic treatment. Finally, it is an object of the present invention to provide a method for manufacturing of a stable fermented milk product with improved shelf life, e.g. where acidification and change in flavour upon storage is reduced.

### SUMMARY OF THE INVENTION

The present inventors have surprisingly found that acidification of a fermented milk drink during storage (the so-called post acidification) can be reduced by treating the milk substrate to be fermented with a transglutaminase enzyme, and thus the shelf life (or storage life) of the drink can be improved. Based on this surprising finding, in one aspect, the present invention relates to a method for improving the shelf life of an acidified milk product (e.g. by reduction the post-acidification), said method comprises the following steps:

a) providing a milk substrate comprising protein;
b) treating the milk substrate with an enzyme having transglutaminase activity; and
c) acidifying the milk substrate, e.g. by fermenting with a microorganism.

The use of enzymes having transglutaminase activity for modification of food proteins, including dairy proteins, is known in the prior art. For instance, JP2835940-B2 describes manufacturing of a milk protein containing acid beverage, and shows that a milk drink comprising dissolved skim milk powder treated with transglutaminase, followed by chemical acidification, retains opaque white turbidity upon heat sterilization due to less precipitation of milk protein. EP0671885 describes a method for production of a milk like product comprising transglutaminase treatment followed by acidification. Herein, a transglutaminase treated milk like product where acidification is performed as a biological fermentation is shown to exhibit a consistency of a semi-solid yoghurt. Treatment with transglutaminase during the manufacturing of fermented milk products is known to increase the viscosity of the product. WO2007/060288 demonstrates that addition of transglutaminase during the production of fermented milk products such as yoghurt allows for reducing the protein content of the milk substrate to still obtain a yoghurt having a high viscosity.

However, it is not disclosed that transglutaminase treatment can extend the shelf life of an acidified milk product, e.g. with respect to post acidification, flavour stability, sedimentation stability, etc.

Further, the present inventors have also surprisingly found that a fermented milk drink produced with transglutaminase has improved flavour stability compared to a fermented milk drink produced without transglutaminase. Consequently, in another aspect, the present invention relates to a method for reducing the change in flavour of a fermented milk product, said method comprising:

a) providing a milk substrate having a protein;
b) treating the milk substrate with an enzyme having transglutaminase activity; and
c) acidifying, e.g. by adding an acid or by fermenting the milk substrate with a microorganism.

In the above methods, step b) may be performed before, during or after step c). The acidified milk drink produced by any method of the present invention may be drinkable, i.e. to be consumed as a beverage, or it may be spoonable or firm (solid) form, so-called set-type.

Also, the present inventors have surprisingly found that stability of a fermented milk drink during storage (esp. sedimentation stability) can be improved by treating the milk substrate with a transglutaminase enzyme (esp. when the transglutaminase is added to the milk during acidification, and when the resulting milk drink is subjected to low shear homogenisation), and thus the shelf life of the drink can be improved. The milk drink was free of pectin. Based on this surprising finding, in a further aspect, the present invention relates to a method for improving the shelf life of an acidified milk product, said method comprising:

a) providing a milk substrate comprising protein;
b) treating the milk substrate with an enzyme having transglutaminase activity; and
c) fermenting the milk substrate with a microorganism;
wherein step b) is performed before, during or after step c).

In an other aspect, the invention relates to a method for improving the sedimentation stability of an acidified milk product, said method comprising:

a) providing a milk substrate comprising protein;
b) treating the milk substrate with an enzyme having transglutaminase activity; and
c) fermenting the milk substrate with a microorganism;
wherein step b) is performed before, during or after step c).

Further, the present inventors have also surprisingly found that a fermented milk drink produced with transglutaminase (esp. when the transglutaminase is added to the milk during acidification, and when the resulting milk drink is subjected to low shear homogenisation) has improved mouth feel compared to a fermented milk drink produced without transglutaminase. Consequently, in yet another aspect, the present invention relates to a method for improving the mouth feel of a fermented milk product, said method comprising:

a) providing a milk substrate having a protein;
b) treating the milk substrate with an enzyme having transglutaminase activity; and
c) acidifying, e.g. by adding an acid or by fermenting the milk substrate with a microorganism;
wherein step b) is performed before, during or after step c).

### DETAILED DISCLOSURE OF THE INVENTION

In its broadest aspect, the present invention related to a method for improving the shelf life of an acidified milk product, said method comprising:

a) providing a milk substrate;
b) acidifying the milk substrate, e.g. by adding an acid or by fermenting with a microorganism; and
c) treating the milk substrate with an enzyme having transglutaminase activity;
wherein step c) is performed before, during or after step b).

In a second aspect, the present invention relates to a method for improving the shelf life of an acidified milk product, said method comprising:

a) providing a milk substrate comprising protein;
b) treating the milk substrate with an enzyme having transglutaminase activity; and
c) acidifying the milk substrate, e.g. by fermenting with a microorganism.

In interesting embodiments, the improved shelf life is due to reduced post-acidification and/or reduced change in flavour of the milk product. Thus, in a second aspect, the present invention relates to a method for reducing the post-acidification of an acidified milk product, said method comprising:

a) providing a milk substrate comprising protein;
b) treating the milk substrate with an enzyme having transglutaminase activity; and
c) fermenting the milk substrate with a microorganism, and in a third aspect, to a method for reducing the change in flavour of an acidified milk product, said method comprising:
a) providing a milk substrate having a protein;
b) treating the milk substrate with an enzyme having transglutaminase activity; and
c) acidifying, e.g. by adding an acid or by fermenting the milk substrate with a microorganism.

In all methods step b) may performed before, during or after step c). An acid to be used is an organic or an inorganic acid, such as lactic acid, LBA, GDL, acetic acid, phosphoric acid, etc.

In a third aspect, the present invention relates to a method for improving the sedimentation stability of an acidified milk product, said method comprising:

a) providing a milk substrate;
b) treating the milk substrate with an enzyme having transglutaminase activity; and
c) acidifying, e.g. by adding an acid or by fermenting the milk substrate with a microorganism;
wherein step b) is performed before, during or after step c).

In a fourth aspect, the present invention relates to a method for improving the mouth feel of an acidified milk product, said method comprising:

a) providing a milk substrate;
b) treating the milk substrate with an enzyme having transglutaminase activity; and
c) acidifying, e.g. by adding an acid or by fermenting the milk substrate with a microorganism;
wherein step b) is performed before, during or after step c).

In a fifth aspect, the present invention relates to a method for producing an acidified milk drink, said method comprising:

a) providing a milk substrate;
b) treating the milk substrate with an enzyme having transglutaminase activity;
c) acidifying, e.g. by adding an acid or by fermenting the milk substrate with a microorganism; and
d) homogenizing the acidified and enzymatic treated milk substrate under low shear conditions;
wherein step b) is preferably performed before or during step c).

Interesting embodiments of the methods of the invention are as follows:
The method wherein the milk substrate is subjected to pasteurization before fermentation/acidification and the enzyme treatment is performed before pasteurization.
The method wherein the milk substrate is subjected to heat treatment prior to treatment with the enzyme having transglutaminase activity. Preferably, such heat treatment results in more than 50% denaturation of the whey protein in the milk substrate.
The method, wherein the fermented milk substrate is mixed with a syrup and the mixture is subjected to homogenization to obtain the acidified milk drink.
The method wherein the milk substrate is subjected to pasteurization before acidification and the enzyme treatment is performed before pasteurization.
The method wherein the milk substrate is subjected to homogenization under low shear conditions after acidification and enzyme treatment.
The method wherein glutathione is added to the milk substrate prior to treatment with the enzyme having transglutaminase activity.
The method wherein the microorganism is a lactic acid bacterium.
The method wherein the fermented or acidified milk substrate (e.g. obtained in step c) is mixed with a syrup and the mixture is subjected to homogenization.
The method wherein the acidified milk product is selected from the group consisting of: an acidified milk drink (e.g. made by adding acid), a fermented milk drink, a fermented or acidified set-type product (e.g. a set-type yoghurt), and a fermented or acidified spoonable product (e.g. a spoonable yoghurt).
The method wherein the fermented or acidified milk substrate (e.g. obtained in step c) is diluted at least 1.5 times (with e.g. water, milk or milk substrate) to obtain the acidified milk drink.
The method wherein the acidified milk drink is to be consumed as a beverage.
The method wherein the acidified milk drink has a milk solid non-fat content of less than 8%.
The method wherein the acidified milk drink has a fat content of less than 2%.
The method wherein the acidified milk drink has a fat content of less than 0.5%.
The method wherein the enzyme having transglutaminase activity is recombinantly produced.
The method wherein the enzyme having transglutaminase activity is obtained from a bacterium belonging to the genus Streptomyces.

In another aspect, the present invention relates to an acidified milk product obtainable by any method of the invention. The product may be packaged, e.g. in a sealed container having a volume in the range of 25 to 1500 ml. In preferred embodiments, the acidified milk of the invention is free, or substantially free of stabilizers like HM pectin, CMC, Soya Bean Fibre/Soya Bean Polymer, Alginate. By substantially free should be understood that the drink comprise less than 5% (e.g. less than 4%, less than 3% or even less than 2% or 1%) stabilizers or thickeners.

In a last aspect, the present invention relates to the use of an enzyme having transglutaminase activity for improving the shelf life (e.g. reduction of post-acidification or reduction of loss of flavour) of an acidified milk product and/or for improving the sedimentation stability and/or mouth feel of an acidified milk drink, especially the use of transglutaminase for improving the sedimentation stability and/or mouth feel of an acidified milk drink which has been subjected to homogenization under low shear conditions.

### Low Shear Conditions

Low shear conditions may be defined as processing the milk drink in a homogenisator by applying a pressure of less that 120 (or even less than 100, less than 80, less than 60, less than 40, or even less than 20 bars), using a standard dairy homogenisator (such as Rannie homogenisator with 2 steps, model 12.50). Of course other types of homogenisators or mixers may be used in the methods of the invention, eg. conventional mixers, sonicators, and the like.

An acidified milk drink according to the present invention may have a shear stress lower than 40 Pa (obtained at shear rate 300 l/s), preferable less than 30 Pa, but most common between and 20 Pa (at a shear rate of 300 l/s)

The viscosity of acidified milk drinks depends on several factors like SNF (solid non fat), fat level, various protein types (whey proteins, casein, vegetable proteins), protein level, thickeners and/or stabilizers (starch (native starch, modified starch), pectin, alginate, gelatine, CMC, soya been fibre/soya bean polymer, carragenan, guar gum, LBG, alginate and alike) and level of shear rate of the fermented milk eg. final mix of fermented white mass mixed with thickener, stabilizer, fruit preparation, sweetener, aspartame, sugar, fructose, alcohol, juice, strawberry juice, fruit concentrate, orange juice or concentrate, flavour, colours and alike.

Acidified milk drinks stabilized with stabilizers like HM pectin, CMC, Soya Bean Fibre/Soya Bean Polymer, Alginate and alike, needs a high shear rate treatment similar to a homogenization pressure of >120 bar in order to be stable. A shear rate of corresponding to >120 bar decreases the viscosity significantly. But by the use of TGase it is possible to produce a stable acidified milk drink even if the homogenisation pressure is lower than 140 bar even down below 10 bar of homogenization pressure or even by the use of other types of equipment used by the industry to make a homogenous acidified milk drink like back pressure spring, rotor stator mixer, high speed mixer, agitator or alike.

The stability of a yoghurt drink produced with TGase is independent of the shear rate applied to the fermented white mass or white mass in combination with stabilizers like HM pectin, CMC, Soya Bean Fibre/Soya Bean Polymer, Alginate and alike, used by the industry today.

### The Procedure for Measuring the Viscosity of Acidified Milk Drinks

Principle: This method is based on characterisation of texture by a viscometry measurement (constant rate). By a constant rate measurement, viscosity and shear rate are registered as function of shear rate. Selected and calculated parameters from the flow curves are extracted.
Materials: StressTech rheometer with CC 25 (bop/cup) measurement system
Procedure: Before the measurements are started the samples must be tempered to the right temperature at 13° C.

A flow curve is registered by increasing the deformation (shear rate: 0.2707 to 300 s⁻¹) continued by a decreasing of deformation (shear rate: 300 to 0,2707 s⁻¹).

### Settings:

Normal force:
Method: To Gab
Max loading force: 10N
Start measurement when normal force is below: 10N
Time out: 1000 sec.
Approx. sample height: 1.000 mm
   Shear rate:
21 steps—up and down: 0.2707-0.3304-0.4923-0.7334-1-2-4-6-10-25-50-75-100-125-150-175-200-225-250-275-300.
Delay time: 5 sec.
Integration time: 10 sec.

### Acidified Milk Products

The term “acidified milk products” refers to any milk-based product which has been acidified, and includes fermented milk products, and acidified milk drinks.

The term “fermented milk product” includes yoghurt. The term “yoghurt” typically covers a milk product produced by fermentation by a starter culture comprising the combination of a Lactobacillus species (e.g. L. bulgaricus) and Streptococcus thermophilus or any other appropriate combination of microorganisms. The term “spoonable” should be understood as to be consumed using a spoon. The term “spoonable fermented milk product” includes “stirred yoghurt”. The term “stirred yoghurt” specifically refers to a yoghurt product which sustains a mechanical treatment after fermentation, resulting in a softening and liquefaction of the coagulum formed under the fermentation stage. The mechanical treatment is typically but not exclusively obtained by stirring, pumping, filtrating or homogenizing the yoghurt gel, or by mixing it with other ingredients. Stirred yoghurts typically but not exclusively have a milk solid non-fat content of 9 to 15%. The term “set-type fermented milk product” includes a product based on milk which has been inoculated with a starter culture, e.g. a yoghurt starter culture, and packaged next to the inoculating step and then fermented in the package. The term “drinkable fermented milk product”, “acidified milk drink”, “fermented milk drink” and the like includes beverages such as “drinking yoghurt” and similar. The term “drinking yoghurt” typically covers a milk product produced by fermentation by the combination of a Lactobacillus (e.g. L. bulgaricus) and Streptococcus thermophilus. “Drinking yoghurt” is typically consumed by drinking the yoghurt, e.g. directly from the packaging or from a glas/cup or the like. Drinking yoghurt typically have a milk solid non-fat content of 8% or more. Furthermore, the live culture count for drinking yoghurt drinks is typically at least 10E6 cell forming units (CFU) pr ml.

“Acidified milk drinks” according to the present invention include any drinkable product based on acidified milk substrates, thus including fermented milk drinks and liquid yoghurt drinks. In the methods of the present invention, acidification is performed as a fermentation with a microorganism. “Acidified milk drinks” according to the present invention include any drinkable product based on acidified milk substrates, thus including fermented milk drinks and liquid yoghurt drinks. In the methods of the present invention, acidification is performed as a fermentation with a microorganism or by addition of an acid, such as an organic acid (e.g. lactic acid, lactobionic acid or GDL). Acidified milk drinks according to the invention are drinkable in the sense that they are in liquid form and consumed as beverages, i.e. they are suitable for drinking instead of being eaten with a spoon (“spoonable”). “In liquid form” means that the products are in the fluid state of matter thus exhibiting a characteristic readiness to flow. Thus, the shape of a liquid is usually determined by the container it fills, in contrary to e.g. a gel-like substance, which is soft, but not free flowing, such as e.g. yoghurt or pudding. Acidified milk drinks according to the invention may have a viscosity allowing the consumer to drink the products using a straw if desired.

In a preferred aspect, acidified milk drinks according to the invention have a viscosity measured as discharge time from a 10 ml pipette which is substantially the same as the discharge time of an acidified milk drink produced without transglutaminase. In this context, a discharge time which is substantially the same means that it is less than 20% increased, preferably less than 15% increased and more preferably less than 10% increased. An acidified milk drink according to the present invention may have a pH of less than 4.6, preferably less than 4.4, more preferably less than 4.2 and even more preferably about pH 4 or less. In one aspect, the acidified milk drink has a pH of less than 3.8, such as less than 3.6. An acidified milk drink according to the invention may have a fat content of 0 to 2%, preferably below 1.5%, below 1% or below 0.5%, more preferably of about 0.1% or less. The acidified milk drink may have a milk solid non-fat content of less than 20%, preferably less than 8.5%, less than 8%, less than 7.5%, less than 7%, less than 6.5% or less than 6%, and more preferably of about 5%. An acidified milk drink according to the invention may have a protein content of between 0.5 and 4%. In one preferred aspect, the acidified milk drink has a protein content of below 1%. In another preferred aspect, the acidified milk drink has a protein content of between 2% and 3%.

An acidified milk drink according to the invention may have a shelf life of more than 7 days, preferably more than 14 days, more preferably more than 28 days, such as more than 3 months. By the term “shelf-life” as used herein should be understood the time-period from the finalisation of a product and until this product, when stored properly and under the conditions recommended by the manufacturer, becomes unacceptable to the consumer. A TGase treated acidified milk drink according to the present invention has an increased stability, e.g. with regards to shelf life, acidity and flavour. The stability may be determined after having stored the acidified milk drink for an appropriate number of days by measuring the change, e.g in pH and/or flavour. An acidified milk drink according to the present invention has an improved sedimentation stability. The stability may be determined after having stored the acidified milk drink for an appropriate number of days by measuring the height of the whey collecting on the surface because of syneresis. It may also be determined after accelerated syneresis, such as by centrifugation.

The term “mouthfeel” (or mouth feel) as used herein describes all tactile observations related with the texture and sensation of texture in the mouth, including the characteristic “creaminess” which usually refers to the mouthfeel of fat or cream. Mouthfeel—which may be defined as a category of sensations occurring in the oral cavity, related to the oral tissues and their perceived condition (e.g. drying, coating)—is an important sensory property of acidified milk products (Barnes et al., 1991, Journal of Dairy Science 74:2089-2099, Lawless and Heyman (1999) Sensory evaluation of food: principles and practices. Aspen Publishers, Inc., Gaithersburg, Md.).

“Milk substrate”, in the context of the present invention, may be any raw and/or processed milk material that can be subjected to acidification according to the method of the invention. Thus, useful milk substrates include, but are not limited to, solutions/suspensions of any milk or milk like products comprising protein, such as whole or low fat milk, skim milk, buttermilk, reconstituted milk powder, condensed milk, dried milk, whey, whey permeate, lactose, mother liquid from crystallization of lactose, whey protein concentrate, or cream. Obviously, the milk substrate may be milk. The term “milk” is to be understood as the lacteal secretion obtained by milking any mammal, such as cows, sheep, goats, buffaloes or camels. In a preferred embodiment, the milk is cow's milk.

In one aspect of the present invention, the milk substrate is more concentrated than raw milk, i.e. the protein content is higher than in raw milk. In this aspect, the protein content is more than 5%, preferably more than 6%, such as more than 7%, more preferably more than 8%, such as more than 9% or more than 10%. Preferably, the lactose content is also higher than in raw milk, such as more than 7%, more than 8%, more than 9%, more than 10%, more than 11% or more than 12%. In a preferred embodiment of this aspect, the milk substrate is a concentrated aqueous solution of skim milk powder having a protein content of more than 5% and a lactose content of more than 7%.

In the context of the present invention, percentages defining the content of the milk substrate or the content of the acidified milk drink are mass percentages, i.e. the mass of a substance (e.g. protein or lactose) as a percentage of the mass of the entire solution (milk substrate or acidified milk drink). Thus, in a milk substrate having a protein content of more than 5%, the mass of the proteins constitutes more than 5% of the mass of the milk substrate. Preferably, at least part of the protein in the milk substrate is proteins naturally occurring in milk, such as casein or whey protein. However, part of the protein may be proteins which are not naturally occurring in milk.

Prior to fermentation, the milk substrate may be homogenized and pasteurized according to methods known in the art. “Homogenizing” as used herein means intensive mixing to obtain a soluble suspension or emulsion. If homogenization is performed prior to fermentation, it may be performed so as to break up the milk fat into smaller sizes so that it no longer separates from the milk. This may be accomplished by forcing the milk at high pressure through small orifices.

“Pasteurizing” as used herein means treatment of the milk substrate to reduce or eliminate the presence of live organisms, such as microorganisms. Preferably, pasteurization is attained by maintaining a specified temperature for a specified period of time. The specified temperature is usually attained by heating. The temperature and duration may be selected in order to kill or inactivate certain bacteria, such as harmful bacteria. A rapid cooling step may follow.

In the methods of the present invention, the milk substrate is acidified by fermentation with a microorganism. Optionally, such acidification by fermentation is combined with chemical acidification of the milk substrate. “Fermentation” in the methods of the present invention means the conversion of carbohydrates into alcohols or acids through the action of a microorganism. Preferably, fermentation in the methods of the invention comprises conversion of lactose to lactic acid.

In the context of the present invention, “microorganism” may include any bacterium or fungus being able to ferment the milk substrate. The microorganisms used for most fermented milk products are selected from the group of bacteria generally referred to as lactic acid bacteria. As used herein, the term “lactic acid bacterium” designates a gram-positive, microaerophilic or anaerobic bacterium, which ferments sugars with the production of acids including lactic acid as the predominantly produced acid, acetic acid and propionic acid. The industrially most useful lactic acid bacteria are found within the order “Lactobacillales” which includes Lactococcus spp., Streptococcus spp., Lactobacillus spp., Leuconostoc spp., Pseudoleuconostoc spp., Pediococcus spp., Brevibacterium spp., Enterococcus spp. and Propionibacterium spp. Additionally, lactic acid producing bacteria belonging to the group of the strict anaerobic bacteria, bifidobacteria, i.e. Bifidobacterium spp., are generally included in the group of lactic acid bacteria. These are frequently used as food cultures alone or in combination with other lactic acid bacteria,

Lactic acid bacteria are normally supplied to the dairy industry either as frozen or freeze-dried cultures for bulk starter propagation or as so-called “Direct Vat Set” (DVS) cultures, intended for direct inoculation into a fermentation vessel or vat for the production of a dairy product, such as an acidified milk drink. Such cultures are in general referred to as “starter cultures” or “starters”.

Commonly used starter culture strains of lactic acid bacteria are generally divided into mesophilic organisms having optimum growth temperatures at about 30° C. and thermophilic organisms having optimum growth temperatures in the range of about 40 to about 45° C. Typical organisms belonging to the mesophilic group include Lactococcus lactis, Lactococcus lactis subsp. cremoris, Leuconostoc mesenteroides subsp. cremoris, Pseudoleuconostoc mesenteroides subsp. cremoris, Pediococcus pentosaceus, Lactococcus lactis subsp. lactis biovar. diacetylactis, Lactobacillus casei subsp. casei and Lactobacillus paracasei subsp. paracasei. Thermophilic lactic acid bacterial species include as examples Streptococcus thermophilus, Enterococcus faecium, Lactobacillus delbrueckii subsp. lactis, Lactobacillus helveticus, Lactobacillus delbrueckii subsp. bulgaricus and Lactobacillus acidophilus.

Also the strict anaerobic bacteria belonging to the genus Bifidobacterium including Bifidobacterium bifidum and Bifidobacterium longum are commonly used as dairy starter cultures and are generally included in the group of lactic acid bacteria. Additionally, species of Propionibacteria are used as dairy starter cultures, in particular in the manufacture of cheese. Additionally, organisms belonging to the Brevibacterium genus are commonly used as food starter cultures.

Another group of microbial starter cultures are fungal cultures, including yeast cultures and cultures of filamentous fungi, which are particularly used in the manufacture of certain types of cheese and beverage. Examples of fungi include Penicillium roqueforti, Penicillium candidum, Geotrichum candidum, Torula kefir, Saccharomyces kefir and Saccharomyces cerevisiae.

In a preferred embodiment of the present invention, the microorganism used for fermentation of the milk substrate is Lactobacillus casei or a mixture of Streptococcus thermophilus and Lactobacillus delbrueckii subsp. bulgaricus. Optionally, the fermented milk substrate may be subjected to heat treatment to inactivate the microorganism.

Fermentation processes to be used in production of acidified milk drinks are well known and the person of skill in the art will know how to select suitable process conditions, such as temperature, oxygen, amount and characteristics of microorganism(s) and process time. Obviously, fermentation conditions are selected so as to support the achievement of the present invention, i.e. to obtain a fermented milk product suitable in the production of an acidified milk drink.

Likewise, the skilled person will know if and when additives such as, e.g., carbohydrates, flavours, minerals, enzymes (e.g. rennet, lactase and/or phospholipase) are to be used in production of acidified milk drinks according to the invention.

Optionally, the fermented milk substrate may be diluted to obtain the acidified milk drink. In one embodiment, the fermented milk substrate is diluted at least 1.5 times, preferably at least 2 times, at least 2.5 times or at least 3 times. It may be diluted with water or an aqueous solution of any kind. “Diluted at least 1.5 times” in the context of the present invention means that the fermented milk substrate is diluted so that its volume is increased by at least 50%.

In one embodiment, a syrup is added to the fermented milk substrate. “Syrup” in the context of the present invention is any additional additive ingredient giving flavour and/or sweetness to the final product, i.e. the acidified milk drink. It may be a solution comprising, e.g., sugar, sucrose, glucose, liquid sugar of fructose, aspartame, sugar alcohol, fruit concentrate, orange juice, strawberry juice and/or lemon juice.

The mixture of the fermented milk substrate and the syrup may be homogenized using any method known in the art. The homogenization may be performed so as to obtain a liquid homogenous solution which is smooth and stable. Homogenization of the mixture of the acidified milk substrate and the syrup may be performed by any method known in the art, such as by forcing the milk at high pressure through small orifices.

In another embodiment of the invention, water is added to the fermented milk substrate, and the mixture of fermented milk substrate and water is homogenized.

The methods of the present invention comprise treatment of the milk substrate with an enzyme having transglutaminase activity. The enzyme treatment may be performed prior to fermentation, such as before inoculation with the microorganism. The enzyme treatment may be performed at the same time as the fermentation. In one embodiment, the enzyme is added before, at the same time or after inoculation of the milk substrate with a microorganism, and the enzyme reaction on the milk substrate takes place at essentially the same time as it is being fermented. Alternatively, the enzyme treatment may be performed after fermentation. If the acidified milk substrate is mixed and optionally homogenized with the syrup, the enzyme treatment may be performed before or after this. The enzyme may be added at the same time or after the syrup, but before homogenization, or it may be added after the acidified milk substrate and the syrup have been mixed and homogenized. In a preferred embodiment, enzyme treatment is performed before or during fermentation. In a more preferred embodiment, the milk substrate is subjected to pasteurization prior to fermentation, and the enzyme treatment is performed before pasteurization. The pasteurization may thus inactivate the enzyme.

In another preferred embodiment, the milk substrate is subjected to heat treatment, such as pasteurization, prior to treatment with transglutaminase. The heat treatment may be performed so that more than 50%, preferably more than 60%, more than 70% or more than 80%, of the whey protein in the milk substrate is denatured. In the context of the present invention, whey protein is denatured when it sediments at pH 4.5. In a more preferred embodiment, the milk substrate is subjected to heat treatment followed by homogenisation prior to treatment with transglutaminase. In another preferred embodiment, yeast extract or a reducing agent such as glutathione is added to the milk substrate prior to treatment with transglutaminase.

Another heat treatment, such as a pasteurization, may be performed after the enzyme treatment so as to inactivate the enzyme.

The enzyme having transglutaminase activity is added in a suitable amount to achieve the desired degree of protein modification under the chosen reaction conditions. The enzyme may be added at a concentration of between 0.0001 and 1 g/L milk substrate, preferably between 0.001 and 0.1 g/L milk substrate. Dosing in units, the enzyme may be added at a concentration of between 0.5 TGHU (TransGlutaminase Hydroxamate Units) and 20 TGHU TGase/g protein in the milk substrate, preferably between 2 and 10 TGHU TGase/g protein in the milk substrate.

The enzymatic treatment in the methods of the invention may be conducted by adding the enzyme to the milk substrate and allowing the enzyme reaction to take place at an appropriate holding-time at an appropriate temperature. The enzyme treatment may be carried out at conditions chosen to suit the selected protein modifying enzyme according to principles well known in the art. The treatment may also be conducted by contacting the milk substrate with an enzyme that has been immobilised.

The enzyme treatment may be conducted at any suitable pH, such as, e.g., in the range of pH 2-10, such as, at a pH of 4-9 or 5-7. It may be preferred to let the enzyme act at the natural pH of the milk substrate, or, if acidification is obtained because of fermentation, the enzyme may act at the natural pH of the milk substrate during the fermentation process, i.e. the pH will gradually decrease from the natural pH of the unfermented milk substrate to the pH of the fermented milk substrate.

The enzyme treatment may be conducted at any appropriate temperature, e.g. in the range 1-80° C., such as 2-70° C. In one embodiment of the present invention, the enzyme treatment may preferably be conducted at a temperature in the range 40-50° C. In another embodiment, the enzyme treatment may preferably be conducted at a temperature of below 10° C.

Optionally, after the enzyme has been allowed to act on the milk substrate, the enzyme protein may be removed, reduced, and/or inactivated by any method known in the art, such as by heat treatment and/or reduction of pH.

Optionally, other ingredients may be added to the acidified milk drink, such as colour; stabilizers, e.g. pectin, starch, modified starch, CMC, etc.; or polyunsaturated fatty acids, e.g. omega-3 fatty acids. Such ingredients may be added at any point during the production process, i.e. before or after fermentation, before or after enzyme treatment, and before or after the optional addition of syrup. In a preferred embodiment, the transglutaminase treatment is combined with the addition of CMC.

### Enzyme Having Transglutaminase Activity

In the methods of the present invention, an enzyme having transglutaminase activity is used in the production of acidified milk drinks, thus decreasing the syneresis upon storage.

In the context of the present invention, an enzyme having transglutaminase activity may be an enzyme which catalyzes the acyl transfer between the gamma-carboxylamide group of peptide-bound glutamine (acyl donor) and primary amines (acyl acceptor), e.g. peptide-bound lysine. Free acid amides and amino acids also react. Proteins and peptides may thus be cross linked in this way. Transglutaminase may also, e.g. if amines are absent, catalyze the deamination of glutamine residues in proteins with H₂O as the acyl acceptor. A transglutaminase according to the invention may also be referred to as, e.g., protein glutamine-gamma-glutamyl transferase, Factor XIIIa, fibrinoligase, fibrin stabilizing factor, glutaminylpeptide gamma-glutamyltransferase, polyamine transglutaminase, tissue transglutaminase, or R-glutaminyl-peptide:amine gamma-glutamyl transferase. The group of transglutaminases comprises but is not limited to the enzymes assigned to subclass EC 2.3.2.13. In the context of the present invention, transglutaminase may also be referred to as TGase.

A transglutaminase to be used according to the invention is preferably purified. The term “purified” as used herein covers enzyme protein preparations where the preparation has been enriched for the enzyme protein in question. Such enrichment could for instance be: the removal of the cells of the organism from which an enzyme protein was produced, the removal of non-protein material by a protein specific precipitation or the use of a chromatographic procedure where the enzyme protein in question is selectively adsorbed and eluted from a chromatographic matrix. The transglutaminase may have been purified to an extent so that only minor amounts of other proteins are present. The expression “other proteins” relate in particular to other enzymes. A transglutaminase to be used in the method of the invention may be “substantially pure”, i.e. substantially free from other components from the organism in which it was produced, which may either be a naturally occurring microorganism or a genetically modified host microorganism for recombinant production of the transglutaminase. However, for the uses according to the invention, the transglutaminase need not be that pure. It may, e.g., include other enzymes.

In a preferred aspect, the transglutaminase to be used in the method of the invention has been purified to contain at least 20%, preferably at least 30%, at least 40% or at least 50%, (w/w) of transglutaminase out of total protein. The amount of transglutaminase may be calculated from an activity measurement of the preparation divided by the specific activity of the transglutaminase (activity/mg EP), or it may be quantified by SDS-PAGE or any other method known in the art. The amount of total protein may, e.g., be measured by amino acid analysis.

In one embodiment of the methods of the invention, the enzyme having transglutaminase activity is recombinantly produced.

In some aspects of the present invention, the enzyme having transglutaminase activity may be of animal, of plant or of microbial origin. Preferred enzymes are obtained from microbial sources, in particular from a filamentous fungus or yeast, or from a bacterium. For purposes of the present invention, the term “obtained from” as used herein in connection with a given source shall mean that the enzyme originates from the source. The enzyme may be produced from the source or from a strain in which the nucleotide sequence encoding the enzyme has been inserted, i.e. a recombinant strain. In a preferred embodiment, the polypeptide obtained from a given source is secreted extracellularly.

The enzyme may, e.g., be obtained from a strain of Agaricus, e.g. A. bisporus; Ascovaginospora; Aspergillus, e.g. A. niger, A. awamori, A. foetidus, A. japonicus, A. oryzae; Chaetomium; Chaetotomastia; Dictyostelium, e.g. D. discoideum; Mucor, e.g. M. javanicus, M. mucedo, M. subtilissimus; Neurospora, e.g. N. crassa; Rhizomucor, e.g. R. pusillus; Rhizopus, e.g. R. arrhizus, R. japonicus, R. stolonifer; Sclerotinia, e.g. S. libertiana; Trichophyton, e.g. T. rubrum; Whetzelinia, e.g. W. sclerotiorum; Bacillus, e.g. B. megaterium, B. subtilis, B. pumilus, B. stearothermophilus, B. thuringiensis; Chryseobacterium; Citrobacter, e.g. C. freundii; Enterobacter, e.g. E. aerogenes, E. cloacae Edwardsiella, E. tarda; Erwinia, e.g. E. herbicola; Escherichia, e.g. E. coli; Klebsiella, e.g. K. pneumoniae; Miriococcum; Myrothesium; Mucor; Neurospora, e.g. N. crassa; Phytophthora, e.g. P. cactorum; Proteus, e.g. P. vulgaris; Providencia, e.g. P. stuartii; Pycnoporus, e.g. Pycnoporus cinnabarinus, Pycnoporus sanguineus; Salmonella, e.g. S. typhimurium; Serratia, e.g. S. liquefasciens, S. marcescens; Shigella, e.g. S. flexneri; Streptomyces, e.g. S. antibioticus, S. castaneoglobisporus, S. lydicus, S. mobaraensis, S. violeceoruber; Streptoverticilium, e.g. S. mobaraensis; Trametes; Trichoderma, e.g. T. reesei, T. viride; Yersinia, e.g. Y. enterocolitica.

In a preferred embodiment, the enzyme is a transglutaminase obtained from a bacterium, e.g. an Actinobacterium from the class Actinobacteria, such as from the subclass Actinobacteridae, such as from the order Actinomycetales, such as from the suborder Streptomycineae, such as from the family Streptomycetaceae, such as from a strain of Streptomyces, such as S. lydicus or S. mobaraensis. In another embodiment, the enzyme is a transglutaminase obtained from a fungus, e.g. from the class Oomycetes, such as from the order Peronosporales, such as from the family Pythiaceae, such as from the genera Pythium or Phytophthora, such as from a strain of Phytophthora cactorum.

According to the present invention, transglutaminase activity may be determined by any method known in the art, such as by incubating the enzyme with gamma-carboxamid group of protein- or peptide-bound glutamine and an amine group, e.g. protein- or peptide-bound lysine, in a buffer at various pH and temperatures, e.g. 50 mM MES at pH 6.5 at 37° C. for 30 minutes. The detection of enzyme activity can be followed by the release of ammonia (e.g. kit obtained from Roche NH3-11877984) or using hydroxylamine as amine group donor (the amount of Glutamic acid gamma-hydroxamate formed in the reaction is detected as a red complex with ferric ions under acid conditions measured at 510 nm) or by determination of the epsilon-(gamma-glutamyl)lysin by amino acid analysis.

### FIGURES

FIG. 1 depicts the shear stress as function of various levels of transglutaminase addition per g protein in the milk substrate and post treatment shear, cf. example 9.

FIG. 2 depicts the height of clarification layer as function of various levels of transglutaminase addition per g protein in the milk substrate and post treatment shear, cf. example 9.

FIG. 3 depicts the shear stress as function of various levels of transglutaminase addition per g protein in the milk substrate and post treatment shear, cf. example 10.

FIG. 4 depicts the height of clarification layer as function of various levels of transglutaminase addition per g protein in the milk substrate and post treatment shear, cf. example 10.

### EXAMPLES

### Example 1

### Preparation of Acidified Milk Drink Samples and Measurement of Viscosity

### Skmp Solution (Skim Milk Powder Solution)

600 ml water+135 g skim milk powder (instant dispersibility from Kerry, Ireland) was incubated at 50° C. for 10 min before use, so a homogeneous solution was obtained.

### Sugar Solution

33 g sucrose
105 g glucose

These sugars were added to 460 ml 20 mM lactic acid buffer, pH 4.0 and incubated at 90° C. for 5 min with stirring and then cooled down to 5° C.

Sugar Solution with Pectin
33 g sucrose
2.25 g pectin (Geno pectin YM-1,5-I from CP Kelco)
105 g glucose

These sugars were added to 460 ml 20 mM lactic acid buffer, pH 4.0 and incubated at 90° C. for 5 min with stirring and then cooled down to 5° C.

### Enzyme

Activa TG (Streptomyces mobaraensis transglutaminase from Ajinomoto, Japan), 1620 TGHU/g, was diluted to give the final concentrations indicated in the Tables. (TGHU=TransGlutaminase Hydroxamate Units).

### Procedure

25 ml SKMP solution was transferred to 100 ml measuring cylinder. 2 ml Enzyme or water (control) was added and incubation was performed for 120 min at 50° C.

The solution was incubated at 85° C. for 30 min in a water bath and hereafter incubated at 43° C. (water bath) for 10 min with magnetic stirring.

3 ml 4 U/I YF-3331 (mixed strain culture containing Streptococcus thermophilus and Lactobacillus delbrueckii subsp. bulgaricus from Chr. Hansen A/S, Denmark) was added and incubation was performed for 16 hours at 43° C.

Hereafter the samples were incubated at 0-5° C. ice/water bath for 20 min.

60 ml sugar solution with or without pectin (0-5° C., ice bath) was added and homogenised with ultrasound (7×5 sec with 9 sec pause) on ice bath.

The samples were placed at 5° C. for 4 days and syneresis was measured.

The viscosity of the acidified milk drink preparation was measured, in sec, as the discharge time from a 10 ml pipette.

### Viscosity Measurements:

| | average of three | |
|---|---|---|
| | measurements | st. dev. |
| | sec | sec |
| 1800 TGHU/l | 9.16 | 0.04 |
| 1800 TGHU/l | 9.04 | 0.04 |
| 450 TGHU/l | 8.82 | 0.40 |
| 450 TGHU/l | 8.86 | 0.21 |
| 180 TGHU/l | 8.52 | 0.02 |
| 180 TGHU/l | 8.61 | 0.38 |
| no TGase | 8.34 | 0.21 |
| no TGase + pectin | 9.46 | 0.10 |
| no TGase + pectin | 9.30 | 0.12 |

### Example 2

### The Effect of Transglutaminase Treatment Before Pasteurization Using Various SKMP Concentrations

### SKMP Solution

231 ml water+69 g skim milk powder (instant dispersibility from Kerry, Ireland) was incubated at 50° C. for 10 min before use, so a homogeneous solution was obtained.

### Sugar Solution

5.66 g sucrose
18.0 g glucose

These sugars were added to 46 ml 20 mM lactic acid buffer, pH 4.0 and incubated at 90° C. for 5 min with stirring and then cooled down to 5° C.

### Enzyme

Activa TG (Streptomyces mobaraensis transglutaminase from Ajinomoto, Japan), 1620 TGHU/g, was diluted to give the final concentrations indicated in the Table.

### Procedure

293 ul SKMP solution+0 ul, 82 ul, 189 ul and 457 ul water for sample 1, 2, 3 and 4, respectively, was transferred to 2 ml eppendorf tube. 30 ul Enzyme or water (control) was added and incubation was performed for 120 min at 40° C.

The solution was incubated at 85° C. for 30 min in a water bath and incubated at 43° C. (water bath) for 10 min with mixing (1000 rpm) in an Eppendorf Thermomixer. Hereafter, 457 ul, 375 ul, 268 ul and 0 ul water was added for sample 1, 2, 3, and 4, respectively.

45 ul 4 U/I YF-3331 (mixed strain culture containing Streptococcus thermophilus and Lactobacillus delbrueckii subsp. bulgaricus from Chr. Hansen A/S, Denmark) solubilised in 9% SKMP was added and incubation was performed for 16 hours at 43° C.

Hereafter, the samples were incubated at 0-5° C. ice/water bath for 20 min.

525 ul sugar solution (0-5° C., ice bath) was added and homogenised with ultrasound (6×5 sec with 9 sec pause) on ice bath.

The samples were placed at 5° C. for 4 days and syneresis was measured.

The syneresis height was measured and the relative syneresis of total milk drink height was calculated.

### Example 3

### Combination of TGase Treatment and Milk Fat or CMC with Final Heat Treatment

### Milk

Arla express milk obtained from supermarket (Bagsvaerd, Denmark) was used:

skimmed milk: 3.5% protein, 4.7% carbohydrate and 0.1% fat;
semi-skimmed milk: 3.4% protein, 4.7% carbohydrate and 1.5% fat; and
full cream milk: 3.4% protein, 4.7% carbohydrate and 3.5% fat.

The milk was incubated at 95° C. for 5 min before use.

### Sugar Solutions

18% sucrose, 20 mM Lactic acid, pH 4.0.
0.75% CMC, 18% sucrose, 20 mM Lactic acid, pH 4.0.
0.375% CMC, 18% sucrose, 20 mM Lactic acid, pH 4.0.
0.15% CMC, 18% sucrose, 20 mM Lactic acid, pH 4.0.

### Enzyme

Purified GMM S. Mobaraensis (SM) TGase 25 mg/ml was diluted to give the final concentration.

### Procedure

375 ul milk was transferred to 2 ml eppendorf tube. 30 ul Enzyme or water (control) was added, hereafter incubation was performed for 120 min at 40° C.

The solution was incubated at 85° C. for 30 min in a water bath and hereafter incubated at 43° C. (water bath) for 10 min with mixing (1000 rpm) in an Eppendorf Thermomixer. 45 ul 4 U/I YF-3331 (mixed strain culture containing Streptococcus thermophilus and Lactobacillus delbrueckii subsp. bulgaricus from Chr. Hansen A/S, Denmark) solubilised in skimmed milk was added and incubation was performed for 16 hours at 43° C.

Hereafter the samples were incubated at 0-5° C. ice/water bath for 20 min.

900 ul sugar solution (0-5° C., ice bath) was added and homogenised with ultrasound (6×5 sec, 50% amplitude, with 9 sec pause) on ice bath. This solution was incubated at 80° C. for 5 min and chilled to 25° C. with mixing (1000 rpm) in an Eppendorf Thermormixer. An additional homogenization was performed with ultrasound (6×5 sec, 50% amplitude, with 9 sec pause) on ice bath. The samples were placed at room temp. 20-24° C. for 10 days and syneresis was measured.

The syneresis height was measured and the relative syneresis of total milk drink height was calculated.

### Example 4

### Combination of TGase Treatment and Milk Fat or CMC without Final Heat Treatment

### Milk

Arla express milk obtained from supermarket (Bagsvaerd, Denmark) was used:

skimmed milk: 3.5% protein, 4.7% carbohydrate and 0.1% fat;
semi-skimmed milk: 3.4% protein, 4.7% carbohydrate and 1.5% fat; and
full cream milk: 3.4% protein, 4.7% carbohydrate and 3.5% fat.

The milk was incubated at 95° C. for 5 min before use.

### Sugar Solutions

18% sucrose, 20 mM Lactic acid, pH 4.0.
0.75% CMC, 18% sucrose, 20 mM Lactic acid, pH 4.0.
0.375% CMC, 18% sucrose, 20 mM Lactic acid, pH 4.0.
0.15% CMC, 18% sucrose, 20 mM Lactic acid, pH 4.0.

### Enzyme

Purified GMM S. Mobaraensis (SM) TGase 25 mg/ml was diluted to give the final concentration.

### Procedure

375 ul milk was transferred to 2 ml eppendorf tube. 30 ul Enzyme or water (control) was added, hereafter incubation was performed for 120 min at 40° C.

The solution was incubated at 85° C. for 30 min in a water bath and hereafter incubated at 43° C. (water bath) for 10 min with mixing (1000 rpm) in an Eppendorf Thermomixer. 45 ul 4 U/1 YF-3331 (mixed strain culture containing Streptococcus thermophilus and Lactobacillus delbrueckii subsp. bulgaricus from Chr. Hansen A/S, Denmark) solubilised in skimmed milk was added and incubation was performed for 16 hours at 43° C.

Hereafter the samples were incubated at 0-5° C. ice/water bath for 20 min.

900 ul sugar solution (0-5° C., ice bath) was added and homogenized with ultrasound (6×5 sec, 50% amplitude, with 9 sec pause) on ice bath. The samples were placed at 5° C. for 14 days and syneresis was measured.

The syneresis height was measured and the relative syneresis of total milk drink height was calculated.

### Example 5

### Comparison of Three Different TGases

### Milk

Arla express skimmed milk obtained from supermarket (Bagsvaerd, Denmark) was used. The milk was incubated at 95° C. for 5 min before use.

### Sugar Solutions

18% sucrose, 20 mM Lactic acid, pH 4.0.

### Enzyme

Purified Streptomyces Mobaraensis (SM) TGase 25 mg/ml, Streptomyces Lydicus (SL) TGase 28 mg/ml and Phytophthora cactorum (PC) 6 mg/ml was diluted to give the final concentration.

### Procedure

375 ul milk was transferred to 2 ml eppendorf tube. 30 ul Enzyme or water (control) was added, hereafter incubation was performed for 120 min at 40° C.

The solution was incubated at 85° C. for 30 min in a water bath and hereafter incubated at 43° C. (water bath) for 10 min with mixing (1000 rpm) in an Eppendorf Thermomixer.

45 ul 4 U/I YF-3331 (mixed strain culture containing Streptococcus thermophilus and Lactobacillus delbrueckii subsp. bulgaricus from Chr. Hansen A/S, Denmark) solubilised in milk was added and incubation was performed for 16 hours at 43° C.

Hereafter the samples were incubated at 0-5° C. ice/water bath for 20 min.

900 ul sugar solution (0-5° C., ice bath) was added and homogenized with ultrasound (6×5 sec, 50% amplitude, with 9 sec pause) on ice bath. The samples were placed at 5° C. for 14 days and syneresis was measured.

### Example 6

### Preparation of Acidified Milk Drink Samples and Assessment of Post-Acidification

Drinking yoghurt was prepared by acidifying a milk base based on 16% skim milk powder dissolved in water. The milk base was heat treated at 85 C for 30 min, cooled to 50 C and added a dosage of 20 TGase units per gram of milk protein. This mixture was incubated at 50 C for 2 hrs. Then the mixture was homogenised at 200 bar at 50 C and hereafter heated to 9° C. for 20 min. After cooling to 43 C a yoghurt culture YF-3331 (Chr. Hansen) was added to the mixture, and fermentation was carried out. At pH 4.5, the yoghurt was cooled to 15 C and added an 25% sucrose solution to obtain a final protein concentration of 2.0%. This product was then homogenized at 150 bar at max. 12 C.

The drinking yoghurt obtained in the process was stored for 14 days and pH was followed.

As a control, a similar drinking yoghurt without TGase was prepared, and a drinking yoghurt containing pectin—a commonly used stabiliser—was prepared. When pectin was added, we used a YM-1,5-L (Cp Kelco) which was dissolved in the sucrose to reach a final concentration in the drinking yoghurt of 0.3%. Table 1 summarises the pH of these three samples during storage at 5 C:

TABLE 1

| Drinking yoghurt | pH Day 1 | pH Day 14 |
|---|---|---|
| With TGase | 4.39 | 4.37 |
| Without TGase | 4.25 | 3.40 |
| With pectin | 4.24 | 3.40 |

Clearly, the drinking yoghurt prepared with TGase shows less post acidification.

### Example 7

### Preparation of Acidified Milk Drink Samples and Assessment of Post-Acidification

Drinking yoghurt was prepared from fresh milk (Arla Express, Arla Dairies). Both skim milk (0.1% fat) and semi skimmed milk (1.5% fat) was used. The milk was pasteurised at 90 C for 20 min and then cooled to 43 C. At that point different dosages of TGase were added together with the yoghurt culture (YF-3331, Chr. Hansen). Fermentation was carried out until pH 4.2 and then the yoghurt was cooled to 13 C and 80% yoghurt base was homogenized with 20% of a sucrose solution to obtain a final amount of 8% sucrose in the drinking yoghurt. The final yoghurts were stored at 5 C for 14 days and pH was followed. The development in pH is shown in Table 2:

TABLE 2

| TGase dosage (Units | Fat content | | | |
|---|---|---|---|---|
| per gram milk | (%) in milk | pH | pH | Delta pH |
| protein) | base | (day 0) | (day 14) | (14 days) |
| 0 | 0.1 | 4.17 | 3.95 | 0.22 |
| 10 | 0.1 | 4.13 | 4.07 | 0.06 |
| 20 | 0.1 | 4.2 | 4.14 | 0.06 |
| 30 | 0.1 | 4.2 | 4.18 | 0.02 |
| 0 | 1.5 | 4.17 | 3.93 | 0.24 |
| 10 | 1.5 | 4.14 | 4.05 | 0.09 |
| 20 | 1.5 | 4.2 | 4.1 | 0.1 |
| 30 | 1.5 | 4.2 | 4.15 | 0.05 |

It is clearly seen that depending on enzyme dosage, TGase significantly reduced post acidification.

### Example 8

### Preparation of Acidified Milk Drink Samples and Assessment of Sedimentation Stability

The improved sedimentation stability combined with high-mouth is demonstrated in the trial with drinking yoghurt produced with the culture F-DVS YF-3331 described below:

Three drinking yoghurts with 0.2% fat and 2.40% protein was produced:

A) Drinking yoghurt
B) Drinking yoghurt stabilized with TGase (20 TGHU/g milk protein)
C) Drinking yoghurt stabilized with 0.3% Genu Pectin YM-115L
Enzyme: Purified Streptomyces Mobaraensis (SM) TGase with activity 425 TGHU/g
Pectin: GENU pectin YM-1,5-L (CP Kelco)

### Procedure

3 L. buckets was filled with milk standardized to 0.29% fat and 3.44% protein by mixing skimmed milk (43% Arla express skummetmælk) and 0.5% fat milk (57% Arla express Minimælk). The milk was pasteurized at 90° C. in 20 minutes and cooled to 5° C. Milk was inoculated with 0.02% of the lactic acid bacteria culture YF-3331 (mixed strain culture containing Streptococcus thermophilus and Lactobacillus delbrueckii subsp. bulgaricus from Chr. Hansen A/S, Denmark). 0.16% Transglutaminase (Purified Streptomyces Mobaraensis (SM) TGase with activity 425 TGHU/g) was added to bucket with milk base B. All buckets were heated to 43° C. and acidification was stopped at pH 4.5, first by cooling to 25° C. in a water bath after stirring with Eurostar mixer (900 o.min 40 sec) and Silverson mixer (3000 o.min 30 sec.) and then to 13° C. in refrigirator.

A 1% pectin solution was produced by heating water to 85° C. before addition of pectin and then mixing 5000 o.min. for 2 min with a Silverson mixer. The pectin solution was cooled to 13° C.

Yoghurt base A and B were added 43% pasteurized water at 13° C., while yoghurt base C was added 43% of the 1% pectin solution at 13° C. All bases were mixed and exposed to the following post treatments at 13° C.: Pumping through homogenizer without pressure, homogenization at 10 bar, 50 bar and 150 bar respectively.

Shear stress of products were measured as shear stress at a shear rate of 300 s⁻¹ with a Stress Tech Rheometer (Rheologica) 1 day after post treatment

### Shear Stress

| | Post treatment | | | |
|---|---|---|---|---|
| Drinking yoghurt | No pressure | 10 bar | 50 bar | 150 bar |
| A | 3.48 Pa | 2.10 Pa | 1.95 Pa | 1.97 Pa |
| B | 15.67 Pa | 17.85 Pa | 16.17 Pa | 14.42 Pa |
| C | 4.75 Pa | 2.93 Pa | 2.14 Pa | 2.05 Pa |

Sedimentation stability was measured as height of whey layer on top of the drinking yoghurt day 2 expressed as percentage of the total height of the yoghurt (Height of Clarification layer (DeltaH(t)) with a Turbiscan LAb Thermo. 20 ml. of the drinking yoghurts were filled into Turbiscan LAb glass bottles and measured just after post treatment and at day 2 using the software TLAb-EXPERT_{—}1.13 with standard settings: Calculation zone: From: 20 mm, To: 42.5 mm, Threshold: −10%.

### Height of Clarification Layer Day 2(%)

| | Post treatment | | | |
|---|---|---|---|---|
| Drinking yoghurt | No pressure | 10 bar | 50 bar | 150 bar |
| A | 21% | 26% | 29% | 30% |
| B | 0% | Missing | 0% | 0% |
| C | 9% | 9% | 9% | 8% |

### Example 9

### The Improved Sedimentation Stability Combined with High-Mouth Feel is Demonstrated in Drinking Yoghurt Fermented to pH 4.20 with the Culture F-DVS YF-3331.

Five drinking yoghurts with 0.2% fat, 2.4% protein and 12% carbohydrate stabilised with different levels of transglutaminase was produced:

| | Transglutaminase addition |
|---|---|
| Vat | (TGHU/g protein) |
| 1 | 0 |
| 2 | 1 |
| 3 | 2 |
| 4 | 5 |
| 5 | 10 |

Enzyme: Purified Streptomyces Mobaraensis (SM) transglutaminase with activity 350 TGHU/g (Novozymes)

### Procedure

Milk standardized to 0.29% fat and 3.49% protein by mixing skimmed milk (93% Arla express skummetmælk) and 38% fat cream (7% Arla piskefløde) was homogenized with 150 bar at 60° C., pasteurized at 95° C. in 5 minutes, cooled to 5° C. and filled into 30 L. vats. Milk was inoculated with 0.02% lactic acid bacteria culture YF-3331 (mixed strain culture containing Streptococcus thermophilus and Lactobacillus delbrueckii subsp. bulgaricus from Chr. Hansen A/S, Denmark) and transglutaminase was added to the vats according to the table above. All vats were heated to 43° C. and acidification was stopped at pH 4.2 by cooling the yoghurts to 15° C. in a plate heat exchanger after stirring of the yoghurts in the vats.

4.53 kg of a 27.9% sucrose solution (pasteurized at 100° C. in 2 min and cooled to 15° C.) was mixed with 10 kg of each yoghurt and the mixes were then homogenized at different pressures, 0, 10, 50 and 150 bar respectively.

Mouth feel of products was measured as shear stress at a shear rate of 300 s⁻¹ with a Stress Tech Rheometer (Rheologica) 28 days after post treatment

### Shear Stress:

| | |
|---|---|
| Transglutaminase | Homogenisation pressure |

| addition | 0 bar | 10 bar | 50 bar | 150 bar |
|---|---|---|---|---|
| 0 TGHU/g | 3.04 Pa | 1.44 Pa | 1.25 Pa | 1.34 Pa |
| 1 TGHU/g | 5.85 Pa | 3.91 Pa | 2.45 Pa | 1.92 Pa |
| 2 TGHU/g | 5.55 Pa | 6.06 Pa | 4.25 Pa | 3.00 Pa |
| 5 TGHU/g | 8.59 Pa | 7.94 Pa | 5.06 Pa | 6.34 Pa |
| 10 TGHU/g | 9.41 Pa | 8.13 Pa | 7.93 Pa | 6.53 Pa |

Sedimentation stability was measured as height of whey layer on top of the drinking yoghurt day 27 expressed as percentage of the total height of the yoghurt (Height of Clarification layer (DeltaH(t)) with a Turbiscan LAb Thermo. 20 ml. of the drinking yoghurts were filled into Turbiscan LAb glass bottles and measured just after post treatment, day 1, 7, 13, 22 and day 27 using the software TLAb-EXPERT_{—}1.13 with standard settings: Calculation zone: From: 20 mm, To: 42.5 mm, Threshold: −10%.

### Height of Clarification Layer Day 27(%):

| | |
|---|---|
| Transglutaminase | Homogenisation pressure |

| addition | 0 bar | 10 bar | 50 bar | 150 bar |
|---|---|---|---|---|
| 0 TGHU/g protein | 31% | 36% | 38% | 43% |
| 1 TGHU/g protein | 17% | 23% | 28% | 29% |
| 2 TGHU/g protein | 0% | 9% | 12% | 26% |
| 5 TGHU/g protein | 0% | 10% | 10% | 14% |
| 10 TGHU/g protein | 0% | 3% | 8% | 13% |

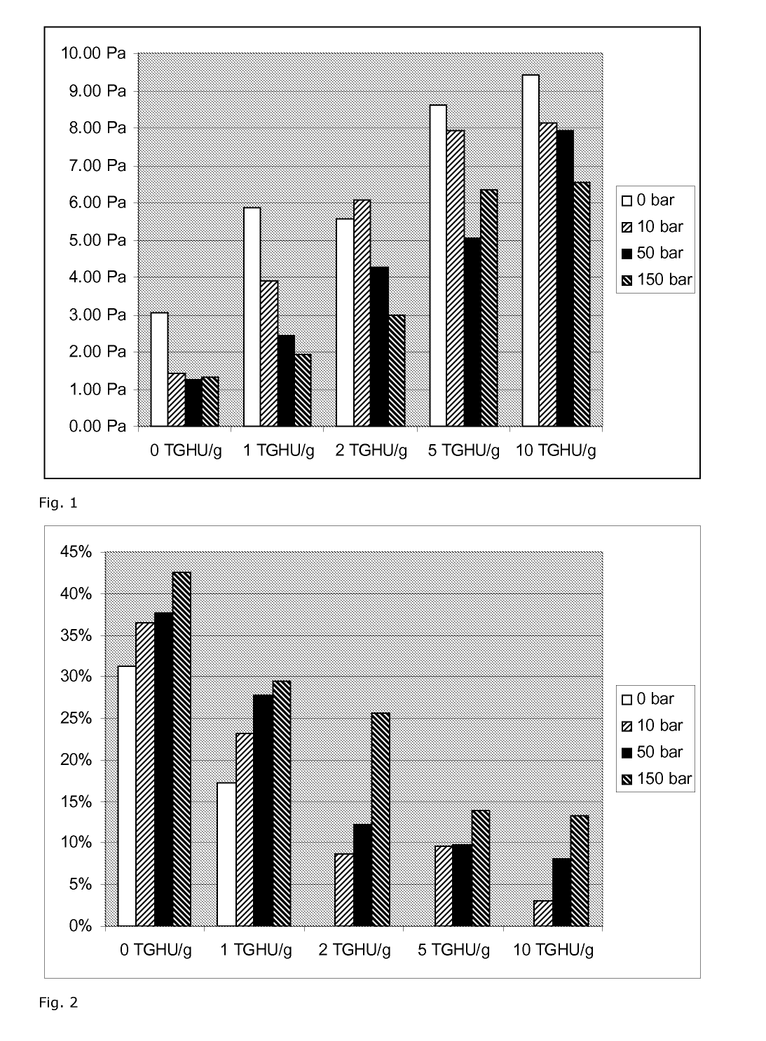

FIG. 2 demonstrate that it is possible to increase sedimentation stability expressed as height of clarification layer by increasing levels of transglutaminase addition. Lower post treatment shear expressed as homogenisation pressure further increase stability. From FIG. 1 it is seen that both increasing levels of transglutaminase and lower post treatment shear increase shear stress. This demonstrates that using transglutaminase as stabiliser for drinking yoghurt provide the possibility to increase both sedimentation stability and mouth feel expressed as shear stress at low post treatment homogenisation pressures opposite other stabilisers.

### Example 10

### The Improved Sedimentation Stability Combined with High-Mouth Feel is Demonstrated in Drinking Yoghurt Fermented to pH 4.30 with the Culture F-DVS YF-3331

Four drinking yoghurts with 0.2% fat, 2.6% protein and 12% carbohydrate stabilised with different levels of transglutaminase was produced:

| | Transglutaminase addition |
|---|---|
| Vat | (TGHU/g protein) |
| 1 | 0 |
| 2 | 2.5 |
| 3 | 5 |
| 4 | 10 |

Enzyme: Purified Streptomyces Mobaraensis (SM) Transglutaminase with activity 996 TGHU/g (Novozymes)

### Procedure

Milk standardized to 0.28% fat and 3.45% protein by mixing skimmed milk (54% Arla express skummetælk) and 0.5% fat milk (45% Arla express minimælk) was homogenized with 150 bar at 60° C., pasteurized at 95° C. in 5 minutes, cooled to 5° C. and filled into 30 L. vats. Milk was inoculated with 0.02% lactic acid bacteria culture YF-3331 (mixed strain culture containing Streptococcus thermophilus and Lactobacillus delbrueckii subsp. bulgaricus from Chr. Hansen A/S, Denmark) and transglutaminase was added to the vats according to the table above. All vats were heated to 43° C. and acidification was stopped at pH 4.3 by cooling the yoghurts to 15° C. in a plate heat exchanger after stirring of the yoghurts in the vats.

2.475 kg of a 33.8% sucrose solution (pasteurized at 100° C. in 2 min and cooled to 15° C.) was mixed with 7.50 kg yoghurt and the mixes were then homogenized at different pressures: 10, 50 and 150 bar respectively.

Mouth feel of products was measured as shear stress at a shear rate of 300 s−1 with a Stress Tech Rheometer (Rheologica) 28 days after post treatment

### Shear Stress:

| Tgase | Homogenisation pressure | | |
|---|---|---|---|
| dosage | 30 bar | 50 bar | 150 bar |
| 0 TGHU/g | 1.32 Pa | 0.88 Pa | 1.06 Pa |
| 2.5 TGHU/g | 5.51 Pa | 5.05 Pa | 4.57 Pa |
| 5 TGHU/g | 7.79 Pa | 6.90 Pa | 6.81 Pa |
| 10 TGHU/g | 7.93 Pa | 7.34 Pa | 6.66 Pa |

Sedimentation stability was measured as height of whey layer on top of the drinking yoghurt day 28 expressed as percentage of the total height of the yoghurt (Height of Clarification layer (DeltaH(t)) with a Turbiscan LAb Thermo. 20 ml. of the drinking yoghurts were filled into Turbiscan LAb glass bottles and measured just after post treatment, day 1, 7, 13, 22 and day 28 using the software TLAb-EXPERT_{—}1.13 with standard settings: Calculation zone: From: 20 mm, To: 42.5 mm, Threshold: −10%.

### Height of Clarification Layer Day 28(%):

| Transglutaminase | Homogenisation pressure | | |
|---|---|---|---|
| addition | 30 bar | 50 bar | 150 bar |
| 0 TGHU/g | 38% | 41% | 41% |
| 2.5 TGHU/g | 11% | 10% | 18% |
| 5 TGHU/g | 7% | 11% | 14% |
| 10 TGHU/g | 9% | 9% | 13% |

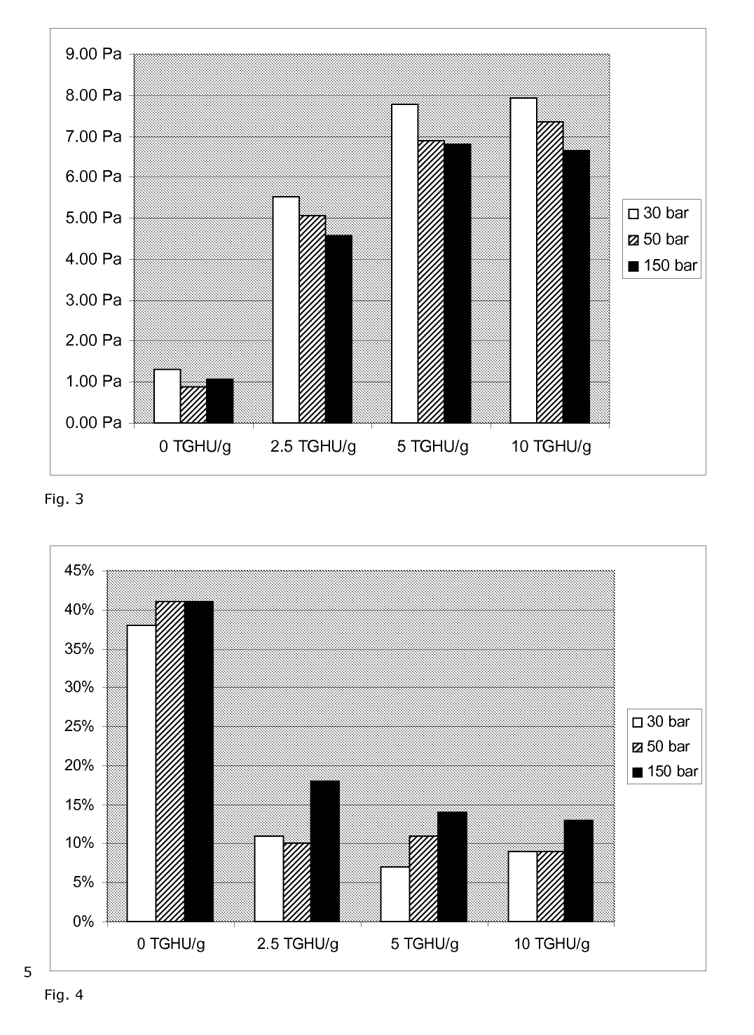

FIG. 4 demonstrate that it is possible to significantly increase sedimentation stability expressed as height of clarification layer already at an addition of 2.5 TGHU transglutaminase/g protein in the milk substrate. Lower post treatment shear expressed as homogenisation pressure further increases stability. From FIG. 3 it is seen that both increasing levels of transglutaminase and lower post treatment shear increase shear stress. This demonstrates that using transglutaminase as stabiliser for drinking yoghurt provide the possibility to increase both sedimentation stability and mouth feel expressed as shear stress at low post treatment homogenisation pressures opposite other stabilisers.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCES

EP1197152B (Ajinomoto), EP1624761B1 (Danone), US2009061046A (NovoZymes)
All references cited in this patent document are hereby incorporated herein in their entirety by reference.

1-31. (canceled)

32. A method for producing an acidified milk drink, comprising:
a) providing a milk substrate;
b) treating the milk substrate with an enzyme having transglutaminase activity;
c) acidifying the milk substrate; and then
d) homogenizing the milk substrate under low shear conditions.

33. The method of claim 32, wherein step b) is performed before or during step c).

34. The method of claim 32, wherein the milk substrate is subjected to pasteurization before acidification and the enzyme treatment is performed before pasteurization.

35. The method of claim 32, wherein the milk substrate is subjected to heat treatment prior to treatment with the enzyme having transglutaminase activity.

36. The method of claim 32, wherein the milk substrate is subjected to homogenization under low shear conditions after acidification and enzyme treatment.

37. The method according to claim 32, wherein step c) comprises adding an acid or fermenting the milk substrate with a microorganism

38. The method of claim 37, wherein step c) comprises fermenting the milk substrate with a lactic acid bacterium.

39. An acidified milk product that is obtainable by the method of claim 32.

40. The acidified milk product of claim 39, wherein said milk product is characterized by an improved sedimentation stability or mouth feel and improved shelf life.

41. A method for producing an acidified milk drink with improved shelf life, comprising:
a) providing a milk substrate;
b) treating the milk substrate with an enzyme having transglutaminase activity; and
c) acidifying the milk substrate
